(19) United States
(12) Patent Application Publication
(10) Pub. No.: US 2007/0002999 A1
(43) Pub. Date: Jan. 4, 2007

(54) Fuel grasping device and fuel exchanger

(76) Inventors: Shinji Nagano, Hitachi (JP); Kunihiko Iwama, Hitachinaka (JP); Ryouji Azumaishi, Hitachiota (JP); Yutaka Kometani, Hitachinaka (JP); Shinya Oomori, Mito (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/477,476

(22) Filed: Jun. 30, 2006

(30) Foreign Application Priority Data
Jul. 1, 2005 (JP) 2005-193297

(51) Int. Cl. G21C 19/00

(52) U.S. Cl. 376/261

(57) ABSTRACT

A fuel grasping device in a nuclear reactor has a telescopic tube including a plurality of tubular members combined with each other to enable a telescopic motion, a fuel gripper arranged at a lower end of the telescopic tube to grasp the fuel assembly for the nuclear reactor, and a driver for winding up and down a rope to perform the telescopic motion vertically. Rotatable members are mounted on the tubular members. A pulling-out preventing projection is used at the joint position of the tubular members. A deceleration of the vertical velocity at the joint position of the tubular members is not necessary so that a time period for the vertical movement can be decreased.

### BACKGROUND OF THE INVENTION

The present invention relates to an equipment for a nuclear power plant, particularly to a fuel grasping device for grasping in a nuclear reactor a fuel and a blade guide to be handled and a fuel exchanger for transferring the grasped fuel and blade guide.

A nuclear electric plant as the nuclear power plant is equipped with the fuel exchanger as the equipment for the nuclear power plant, which fuel exchanger runs along a well pool in the nuclear reactor and a spent fuel storage pool.

The fuel exchanger has a travel carriage running along the well pool in the nuclear reactor and the spent fuel storage pool, a transverse travel carriage running on the travel carriage to transverse each of the pools, and the fuel grasping device mounted on the transverse travel carriage.

Such fuel exchanger is used in operations for exchanging and rearranging a fuel assembly, on which operations the blade guide or fuel assembly for the nuclear reactor is grasped by the fuel grasping device, and the grasped blade guide or fuel assembly is moved between the well pool in the nuclear reactor and the spent fuel storage pool.

The fuel grasping device has a telescopic tube including a plurality of tubular members combined with each other to enable a telescopic motion, a fuel gripper arranged at a lower end of the telescopic tube to grasp the fuel assembly for the nuclear reactor, and a driver for winding up and down a rope to perform the telescopic motion vertically.

The telescopic tube needs to be driven by the driver to perform the telescopic motion when grasping the fuel assembly and bringing down the grasped fuel assembly, bur when such telescopic motion is rapid, it applies an impact damage to a stopper. Therefore, the telescopic motion of the telescopic tube is slow.

For handling speedily the fuel assembly without such slowness, a structure for the telescopic motion of the telescopic tube without the stopper is disclosed. In such structure, the tubular members of the telescopic tube are connected to respective ropes to be wound up and down by drums with the driver. Since velocities in telescopic motion of the tubular members of the telescopic tube are different from each other, a plurality of the drums for the respective ropes have respective diameters different from each other. (Refer to, for example, JP-A-7-181288.)

Another conventional example is known as follows. Each of the tubular members of the telescopic tube is equipped with pulleys at upper and lower ends thereof, and a rope extends from the wind drum of the driver onto the pulleys of the each of the tubular members so that the rope is folded to extend vertically at each of the upper and lower ends of the each of the tubular members.

Further, another rope extends from the wind drum of the driver is fixedly connected to a lowermost one of the tubular members of the telescopic tube so that the rope on the pulleys and the another rope are simultaneously wound up and down in respective directions opposite to each other to perform the telescopic motion of the telescopic tube. (Refer to JP-A-10-132986.)

### BRIEF SUMMARY OF THE INVENTION

If projections (stoppers) for preventing pulling out contact each other at a joint position between upper and lower ones of the tubular members of the conventional telescopic tube so that the tubular members of the conventional telescopic tube are prevented from being pulled out from each other, a vertical velocity of the tubular members of the telescopic tube needs to be decreased to prevent a damage of the projections causing a drop of the tubular members of the telescopic tube when passing the joint position (the projections contact each other), so that the operation for exchanging the fuel is delayed.

Further, if the winding drum is composed of the plurality of the drums of diameters different from each other, although the projections do not contact each other so that the decrease of the velocity of the tubular members is not necessary, a length of the rope to be wound needs to be sufficient for extending from the winding drum to the fuel gripper at the lowermost position thereof, so that a time period for winding the rope deteriorates a speeding up. Further, the increase of the length of the rope to be wound causes an increase in diameter of the winding drum, so that problems of increase in weight of the structure and of increase in volume for mounting the telescopic tube occur.

Further, even if all of the tubular members of the telescopic tube are simultaneously ejected or retracted through single rope with the pulleys at the upper and lower ends of the tubular members of the telescopic tube, the length of the rope to be wound also needs to be sufficient for extending from the winding drum to the fuel gripper at the lowermost position thereof, so that the time period for winding the rope deteriorates the speeding up. Further, in the structure in which the pulleys are arranged at the upper and lower ends of the tubular members of the telescopic tube, all of the tubular members bear a weight and a feeding force applied from the wire by the driver and are simultaneously ejected when the tubular members of the telescopic tube descends. On the other hand, when the tubular members of the telescopic tube ascends by pulling up the fuel gripper through the rope, the tubular members of the telescopic tube is prevented by gravitation from ascending instantly, and the fuel gripper contacts the projection (stopper) of the innermost one of the tubular members to be moved upward to be followed by that the tubular members contact sequentially the respective projections to be moved upward, so that when passing the joint position (the projections contact each other) during the operation of the fuel exchanger, the ascending velocity is decreased.

An object of the present invention is to decrease a time period for telescopic motion of the telescopic tube for the fuel grasping device so that the fuel exchanging operation is accelerated.

First means for achieving the object of the invention is a fuel grasping device comprising a telescopic tube having a plurality of tubular members combined with each other to enable a telescopic motion, a fuel gripper arranged at a lower end of the telescopic tube to grasp a fuel assembly for a nuclear reactor, rotatable members mounted on the tubular members, a first flexible tension member extending between radially inner and outer ones of the tubular members radially adjacent to one of the tubular members through one of the rotatable members on the one of the tubular members, a second flexible tension member connected to any one of the tubular members, and a driver for winding us and down the second flexible tension member.

Further, second means is a fuel exchanger comprising a travel carriage running along a well pool in a nuclear reactor and a spent fuel storage pool, a transverse travel carriage running on the travel carriage to transverse each of the pools, and the fuel grasping device according to any one of claims 1-3 and mounted on the transverse travel carriage.

According to the invention, since an impingement between projections for preventing pulling-out at a joint position between the tubular members of the telescopic tube and an application of a plurality of winding drums different in diameter from each other and a plurality of ropes for the respective tubular members of the telescopic tube do not need to be considered, a time period for telescopic motion of the telescopic tube can be decreased.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWINGS

FIG. 1 is an elevational view of a fuel exchanger in a nuclear electric plant.

FIG. 2 is a horizontal projection view of the fuel exchanger in the nuclear electric plant.

FIG. 3 is a cross sectional view showing a fuel grasping device as an embodiment of the invention at a retracted condition.

FIG. 4 is a cross sectional view showing the fuel grasping device as a first modified sample of the embodiment of the invention at a retracted condition.

FIG. 5 is a cross sectional view showing the fuel grasping device as a second modified sample of the embodiment of the invention at the retracted condition.

FIG. 6a is a cross sectional view showing a half of a telescopic tube defined by an tubular axis thereof at the retracted condition of the fuel grasping device as a third modified sample of the embodiment of the invention, and FIG. 6b is a general view of the telescopic tube.

FIG. 7 is a cross sectional view of the telescopic tube showing an arrangement of pulleys of the fuel grasping device as the third modified sample of the embodiment of the invention.

### DETAILED DESCRIPTION OF THE INVENTION

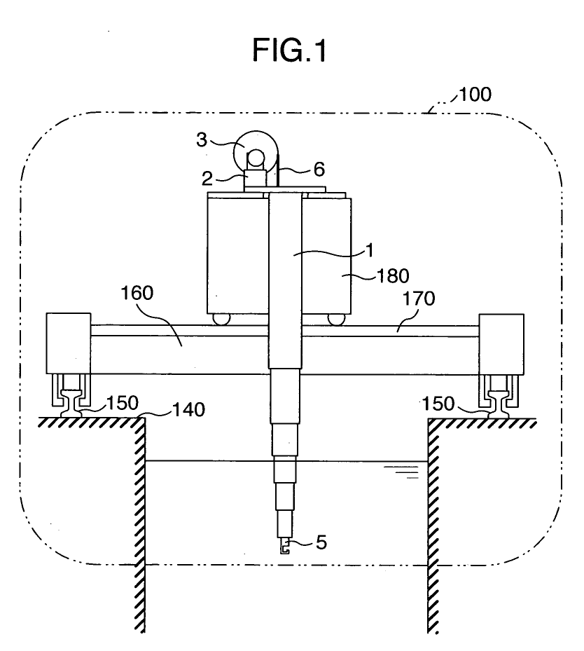

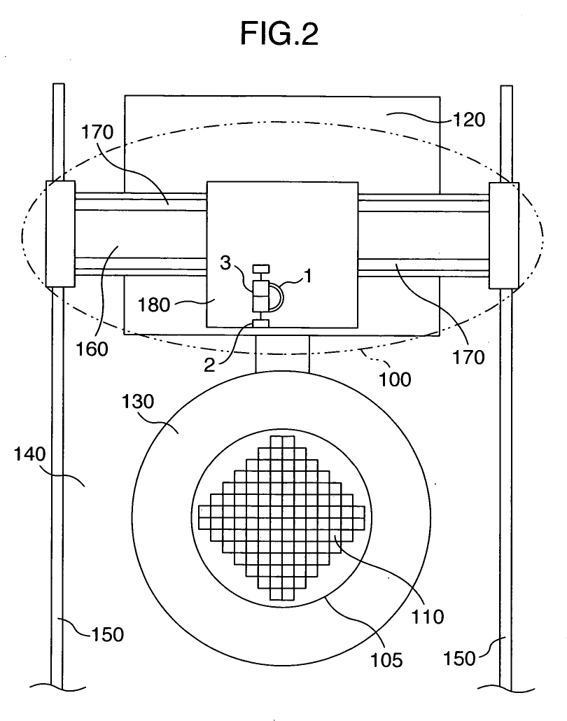

Hereafter, a fuel exchanger is generally explained with making reference to FIGS. 1 and 2. FIG. 1 is a front view showing the whole of the fuel exchanger of the invention, and FIG. 2 is a top view showing the whole structure and used condition of the fuel exchanger of the invention.

In a nuclear reactor mounted in a nuclear electric plant, a fuel assembly 110 in a pressure vessel 105 of the nuclear reactor is exchanged by the fuel exchanger 100 during a periodical inspection with keeping the nuclear reactor at shutdown. In this fuel exchange operation, the spent fuel assembly 110 is taken out of the pressure vessel 105 of the nuclear reactor to be transferred to a spent fuel storage pool 120, and a new fuel assembly 110 is mounted into the pressure vessel 105 of the nuclear reactor, while positions of the fuel assemblies 110 of burnups different from each other are changed with respect to each other in the nuclear reactor.

The fuel exchanger 100 extend over the spent fuel storage pool 120, a nuclear reactor well pool 130 and the pressure vessel 105 of the nuclear reactor, and includes a travel carriage 160 movable on rails 150 mounted along each of the pools on an operating floor 140, and a transverse travel carriage 180 movable on transverse rails 170 mounted on the travel carriage 160, so that the fuel assembly 110 on a central region of the nuclear reactor in the pressure vessel 105 of the nuclear reactor under the nuclear reactor well pool 130 is grasped to be taken out of the nuclear reactor by a fuel gripper 5 mounted at an lower end of a telescopic tube 1 extending vertically downwardly from the transverse travel carriage 180, and is inserted and released from the fuel gripper 5 into a spent fuel storage rack of the spent fuel storage pool 120.

On the other hand, the fuel gripper 5 at the front end of the telescopic tube 1 is capable of clamping and releasing a handle part of an upper end of the fuel assembly 110 through a remote control, and is mounted on the transverse travel carriage 180 of the fuel exchanger 110 through the telescopic tube 1 including a plurality of cylindrical tubular members 1a-1f of diameters different from each other combined to perform a telescopic motion. A driver including a hoisting electric motor 2 and winding drums 3 driven by the hoisting electric motor 2 to wind and unwind a rope so that the telescopic tube 1 is extended and retracted vertically, is mounted on the transverse travel carriage 180. A wire rope 6 as the flexible tension member for transmitting a force for extending and retracting the telescopic tube 1 is wound on the winding drums.

When the fuel assembly 110 is removed from the reactor core and transferred into the spent fuel storage pool 120, when the fuel assembly is transferred from the spent fuel storage pool 120 to the reactor core, and when the fuel assembly 110 are rearranged in the reactor core, the fuel gripper 5 attached to the lower end of the telescopic tube to transfer the fuel assembly 110 needs to be moved vertically.

Further, since such fuel exchanging operation is performed by the fuel exchanger through the remote control, a structure of each carriage of the fuel exchanger needs to be sufficiently rigid, and the arrangement of the rails 150 needs to be sufficiently accurate. A coordinate detector of sufficient accuracy enables the fuel gripper 5 to perform automatic positioning to the fuel assembly and automatic grasping with the telescopic motion of the telescopic tube 1.

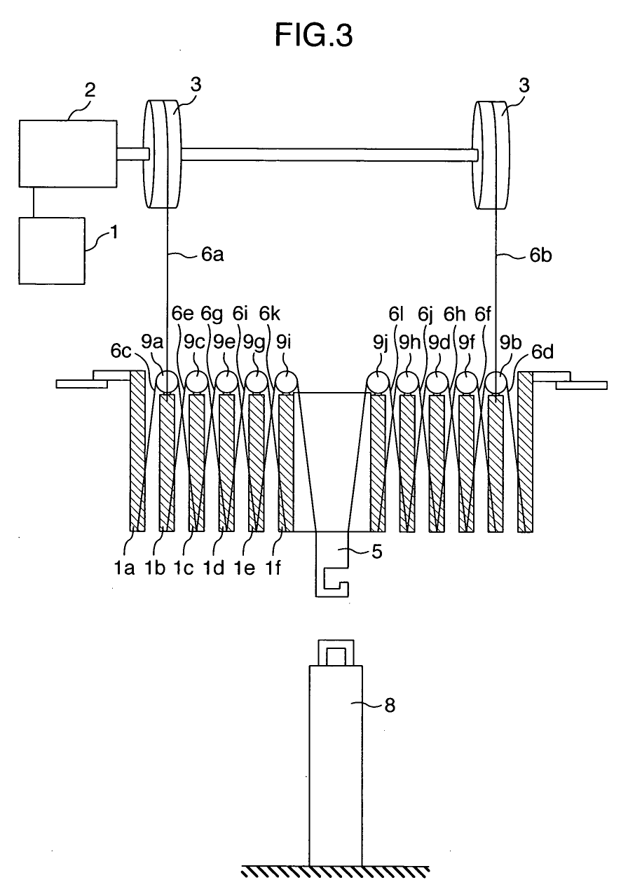

The structure and action of the telescopic tube 1 is explained hereafter with making reference to FIG. 3. That is, it is composed of the fuel gripper 5, the tubular members 1a, 1b, 1c, 1d, 1e and 1f forming the telescopic tube 1, the hoisting electric motor 2, the winding drums 3g and 3h rotationally driven by the electric motor, the wire ropes 6a and 6b connecting the tubular member 1b to each of the winding drums 3g and 3h, the pulleys 9a and 9b mounted on the tubular member 1b, the wire ropes 6c and 6d extending through the pulleys 9a and 9b to be connected to lower ends of the tubular members 1a and 1c, the pulleys 9c and 9d mounted on the tubular member 1c, the pulleys 9e and 9f mounted on the tubular member 1d, the pulleys 9g and 9h mounted on the tubular member 1e, the pulleys 9i and 9j mounted on the tubular member 1f, the wire ropes 6e and 6f extending through the pulleys to be connected to lower ends of the tubular members 1b and 1d, the wire ropes 6g and 6h connected to lower ends of the tubular members 1c and 1e, the wire ropes 6i and 6j connected to lower ends of the tubular members 1d and 1f, and the wire ropes 6k and 6l connected to lower ends of the tubular members 1e and the fuel gripper 5.

The fuel gripper 5 has a cylindrical member at an upper area thereof so that the cylindrical member is vertically movable in the tubular member 1f and restrained by the telescopic tube 1 from moving horizontally.

When the fuel gripper 5 is moved vertically to transfer the fuel assembly from the reactor core or the spent fuel storage pool 120, the winding drums 3g and 3h are rotated to unwind the wire ropes 6a and 6b.

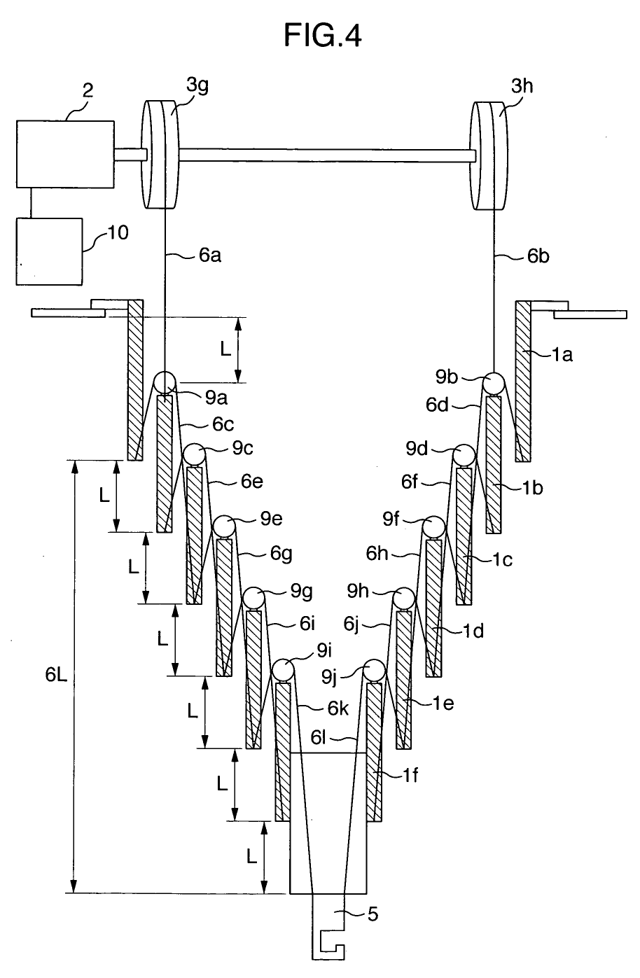

As shown in FIG. 4, when the wire ropes 6a and 6b are unwound by a length L, the tubular member 1b connected to the wire ropes 6a and 6b descends by the length L. When the tubular member 1b descends by the length L, the wire ropes 6c and 6d connected to the tubular member 1c and the lower end of the tubular member 1a run through the pulleys 9a and 9b to decrease a distance between the pulleys 9a and 9b and the tubular member 1a by the length L and increase a distance between the pulleys 9a and 9b and the tubular member 1c by the length L.

Therefore, the tubular member 1c descends with respect to the tubular member 1b by the length L so that the tubular member 1c can be moved vertically downward by length 2L from its original position when the wire ropes 6a and 6b are unwound by the length L.

Similarly, the wire ropes 6e and 6f between the tubular members 1c and 1d run to move the tubular member 1d vertically downward with respect to the tubular member 1c by the length L. That is, simultaneously with unwinding the wire ropes 6a and 6b, the tubular member of smaller diameter adjacent to the tubular member of greater diameter (the fuel gripper 5 adjacent to the tubular member of the smallest diameter) moves vertically downward with respect to the tubular member of greater diameter by the length L by which the wire ropes 6a and 6b are unwound, so that the fuel gripper is moved vertically downward with respect to its original position by a product of the wire rope unwound length L and a number of the tubular members.

This action enables the tubular members to be moved simultaneously while preventing the tubular members from being moved in order. Further, when the fuel assembly is moved vertically upward, the tubular members can move simultaneously as reverse action with respect to the above action so that the tubular members do not need to be pulled in and out with contacts between the pulling-out preventing projections during the vertical motion of the telescopic tube.

Further, the ropes 6a and 6b for extending downward the telescopic tube conventionally need to have a length extending from the winding drums to the fuel gripper 5, but need to have a length extending from the winding drums 3g and 3h to the tubular member 1b as a second one from an uppermost one of the tubular members, so that length of the ropes 6a and 6b to be wound can be decreased.

In the embodiment in FIGS. 3 and 4, a pair of the winding drums 3g and 3h and a pair of the ropes 6a and 6b to be unwound from the winding drums prevent the fuel assembly from falling down by bearing the weight through one of the wire ropes when the other one of the wire ropes are broken off.

Further, the controller 10 adjusts the velocity of the hoisting electric motor 2 to apply S-curved velocity to start and stoppage of the vertical movement of the telescopic tube so that an acceleration applied to the fuel assembly to be transferred vertically can be decreased.

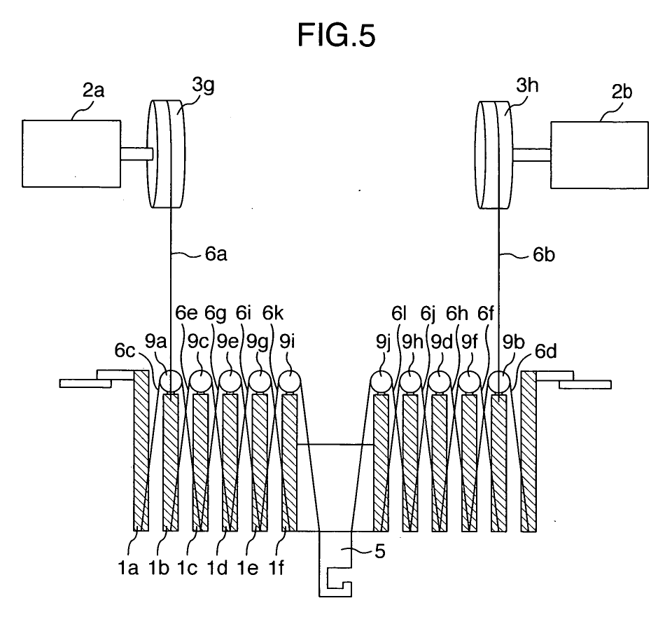

A first modified embodiment of the above described embodiment of the invention is explained with making reference to FIG. 5. In FIG. 5, hoisting electric motors 2a and 2b for the respective winding drums 3g and 3h are driven synchronously to move vertically the tubular members 1a-1f.

Sets of the winding drums and hoisting electric motors are arranged in a circumferential direction of the tubes to connect the wire ropes extending from the respective winding drums to the tubular member 1b as the second one from the uppermost one of the tubular members of the telescopic tube, so that diameter of the wire ropes can be decreased, and the pair of the drivers and the pair of the wire ropes improve safety. The other structure and action are similar to those of the embodiment of FIGS. 1-4.

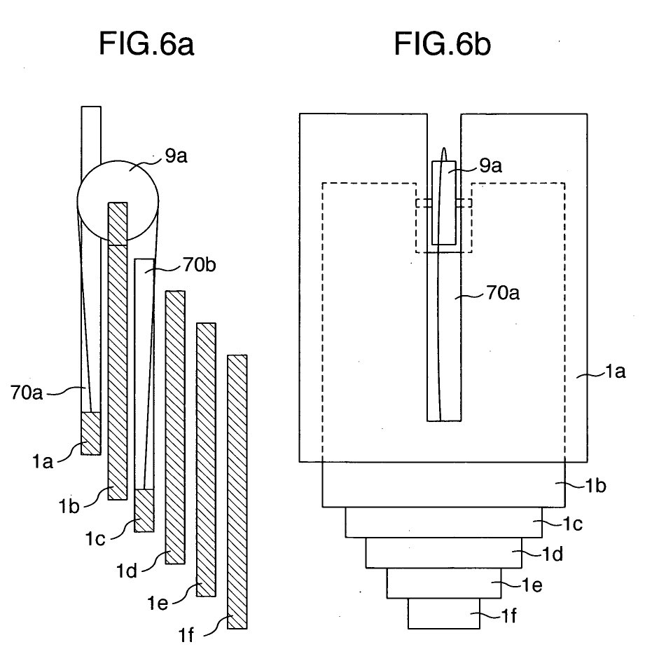

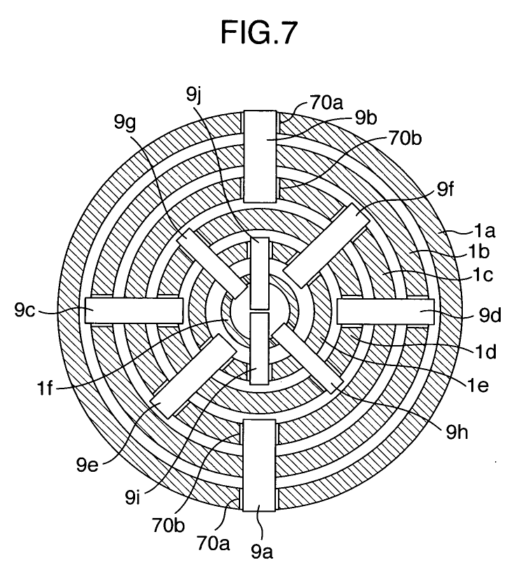

A second modified embodiment of the embodiment of the invention shown in FIGS. 1-4 is explained with making reference to FIGS. 6 and 7.

For preventing a rotation between the conventional tubular members on an axis of the tube, rails are attached to inner surfaces of the tubular members along the axis of the tube, and pairs of rail guides between which the rail is held in the circumferential direction are attached to outer surfaces of the tubular members. The rails held between the rail guides prevent the tubular members from rotating with respect to each other.

On the contrary, in the modified embodiment as shown in FIG. 6, the diameters of the pulleys 9a and 9b mounted on the tubular member 1b are increased to reach the tubular members 1a and 1c adjacent radially, and slits 70a and 70b are formed on the tubular members 1a and 1c adjacent radially to interfere with the pulleys so that the pulleys 9a and 9b and the slits 70a and 70b are used as the rails and rail guides.

The other tubular members have the respective slits adjacent to the pulleys 9c, 9d, 9e, 9f, 9g, 9h, 9i and 9j to act as the rail and rail guide. The pulleys are distributed in the circumferential direction of the tubular members as shown in FIG. 7 to be prevented from interfering with each other.

Therefore, the conventional rail and rail guides for preventing the tubular members from rotating with respect to each other do not need to be used to prevent the structure from being complicated. Further, when the diameters of the pulleys need to be great to satisfy a requirement of curvature radii of the wire ropes 6c-6l, this embodiment is effective. The other structure and action are similar to those of the embodiment of FIGS. 1-4.

The embodiments of the invention achieve the following matters. A deceleration of the vertical velocity at the joint position of the tubular members is not necessary so that a time period for the vertical movement can be decreased. Even when the pulling-out preventing projection is used at the joint position of the tubular members, the pulling-out preventing projection is prevented from being damaged by the contact between the projections. The additional structure has multiple functions to prevent the structure from being complicated.

The invention can be applied to, for example, the fuel exchanger for handling the fuel assembly in the nuclear electric plant.

It should be further understood by those skilled in the art that although the foregoing description has been made on embodiments of the invention, the invention is not limited thereto and various changes and modifications may be made without departing from the spirit of the invention and the scope of the appended claims.

1. A fuel grasping device comprising a telescopic tube having a plurality of tubular members combined with each other to enable a telescopic motion, a fuel gripper arranged at a lower end of the telescopic tube to grasp a fuel assembly for a nuclear reactor,
a rotatable member mounted on one of the tubular members,
a first flexible tension member extending between radially inner and outer ones of the tubular members radially adjacent to the one of the tubular members through the rotatable member on the one of the tubular members,
a second flexible tension member connected to any one of the tubular members for the telescopic motion, and
a driver for winding us and down the second flexible tension member.

2. The fuel grasping device according to claim 1, wherein the radially inner and outer ones of the tubular members have respective slits for enabling the rotatable member to move vertically.

3. The fuel grasping device according to claim 1, wherein the device comprises a plurality if the second flexible tension members.

4. A fuel exchanger comprising a travel carriage capable of running along a well pool in a nuclear reactor and a spent fuel storage pool,
a transverse travel carriage capable of running on the travel carriage to transverse each of the pools, and
the fuel grasping device according to claim 1 and mounted on the transverse travel carriage.

5. A fuel grasping device for grasping and moving a fuel assembly for a nuclear reactor, comprising
a telescopic tube having a plurality of tubular members arranged coaxially to perform a telescopic motion,
a pulley mounted on one of the tubular members in a rotatable manner,
a flexible tension member which contacts a part of an outer periphery of the pulley so that the flexible tension member is movable with respect to the one of the tubular members and is connected to radially inner and outer ones of the tubular members radially adjacent to the one of the tubular members at respective positions of the radially inner and outer ones of the tubular members lower than the highest position of the part of the outer periphery of the pulley so that a vertical relative movement of the radially inner one of the tubular members with respect to the one of the tubular members corresponds to a vertical relative movement of the radially outer one of the tubular members with respect to the one of the tubular members,
a fuel gripper mounted on an innermost one of the tubular members to grasp the fuel assembly, and
a driver for driving vertically any one of the one, radially inner one and outer one of the tubular members to generate the telescopic motion.

6. The fuel grasping device according to claim 5, wherein at least one of the radially inner and outer ones of the tubular members has a vertically extending groove to receive a part of the pulley so that a relative coaxial rotation between the at least one of the radially inner and outer ones of the tubular members and the one of the tubular members is restrained by an engagement between the part of the pulley and the vertically extending groove.
